(19) United States
(12) Patent Application Publication
(10) Pub. No.: US 2026/0212339 A1
(43) Pub. Date: Jul. 23, 2026

(54) Point of Sale Account Card

(71) Applicant: David Hodgson, Bargersville, IN (US)

(72) Inventor: David Hodgson, Bargersville, IN (US)

(21) Appl. No.: 19/029,406

(22) Filed: Jan. 17, 2025

(51) Int. Cl. G06Q 20/34; G06Q 20/20

(52) U.S. Cl. CPC G06Q 20/3433; G06Q 20/204

(57) ABSTRACT

The Point of Sale Account Card includes an interrupt circuit to display a balance on the card and on an account associated with the card with a financial institution at a point of sale (POS) machine before a transaction with the card. A transaction circuit executes a debit or credit on the card and the associated account via the POS machine with the financial institution to include any associated transaction fees. An update circuit updates the balance on the card and the account associated with the card via the POS machine with the financial institution per the debit or credit transaction. The card is used without and without a POS handshaking with the financial institution since a batch update is performed on the card at the next electronic business transaction.

### SUMMARY OF THE INVENTION

The disclosed Point of Sale Account Card for electronic business transactions includes an interrupt circuit configured on the card with electronic logic to display a balance on the card and on an account associated with the card with a financial institution at a point of sale (POS) machine before a transaction with the card. The disclosure also includes a transaction circuit configured on the card with electronic logic to transact a debit or credit on the card and the associated account via the POS machine with the financial institution to include any associated transaction fees. The disclosure yet includes an update circuit configured on the card with electronic logic to update the balance on the card and update the account associated with the card via the POS machine with the financial institution per the debit or credit transaction. The disclosure further includes a card memory configured to read and to write the debit or credit transaction and the card balance and the account balance via the update circuit with the electronic logic. The card is used without and without a POS handshaking with the financial institution since a batch update is performed on the card at the next electronic business transaction.

### BRIEF DESCRIPTION OF THE DRAWINGS

FIG. 1 is a view of the Point of Sale Account Card and electronic state machine circuits in accordance with an embodiment of the present disclosure.

FIG. 2 is a system view of the Point of Sale Account Card in accordance with an embodiment of the disclosure.

FIG. 3 is a flow chart of steps in a Point of Sale Account Card transaction in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

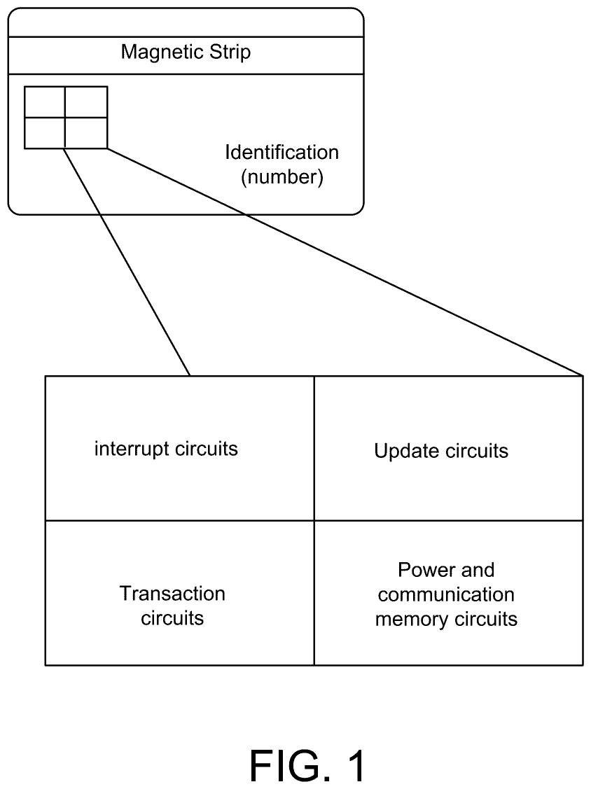

FIG. 1 is a view of the Point of Sale Account Card and electronic state machine circuits in accordance with an embodiment of the present disclosure. The view includes an interrupt circuit configured on the card with electronic logic to display a balance on the card and on an account associated with the card with a financial institution at a point of sale (POS) machine before a transaction with the card. The view also includes a transaction circuit configured on the card with electronic logic to transact a debit or credit on the card and the associated account via the POS machine with the financial institution to include any associated transaction fees. The view yet includes an update circuit configured on the card with electronic logic to update the balance on the card and update the account associated with the card via the POS machine with the financial institution per the debit or credit transaction. The view further includes a card memory configured to read and to write the debit or credit transaction and the card balance and the account balance via the update circuit with the electronic logic. The card is used without and without a POS handshaking with the financial institution since a batch update is performed on the card at the next electronic business transaction. The card circuits reside on a back of the card and in other embodiments on the front of the card depending on design considerations and preferences.

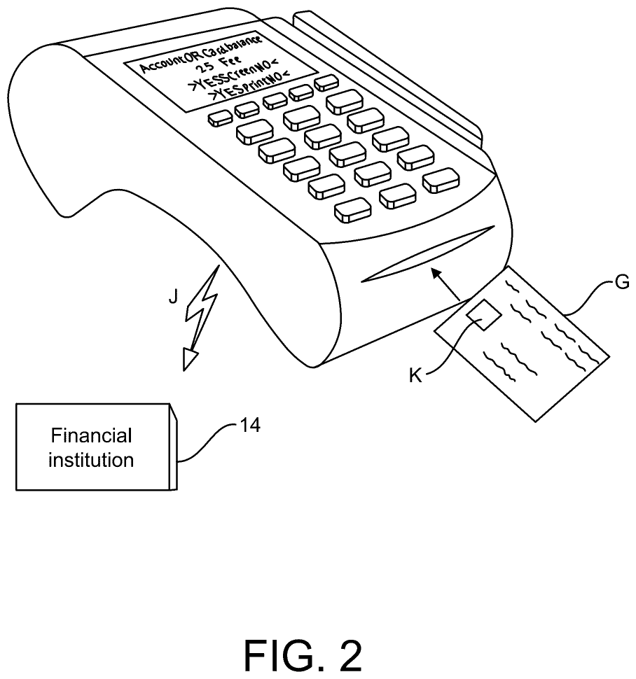

FIG. 2 is a system view of the Point of Sale Account Card in accordance with an embodiment of the disclosure. The view includes the POS machine A also known as a card reader with connections to the internet and cloud memory over wireless connections shown as J. The view also includes the touch screen for input/output referenced as B to choose card memory also known as the card balance and account balance via the POS machine with a financial institution. The view additionally includes the card reader C, the keypad D, the card chip insertion slot E, the disclosed point of sale account card itself G, and the financial institution represented by reference H. The card circuits and electronic logic are depicted by reference K on a front of the card but also reside on a back of the card in embodiments of the disclosure.

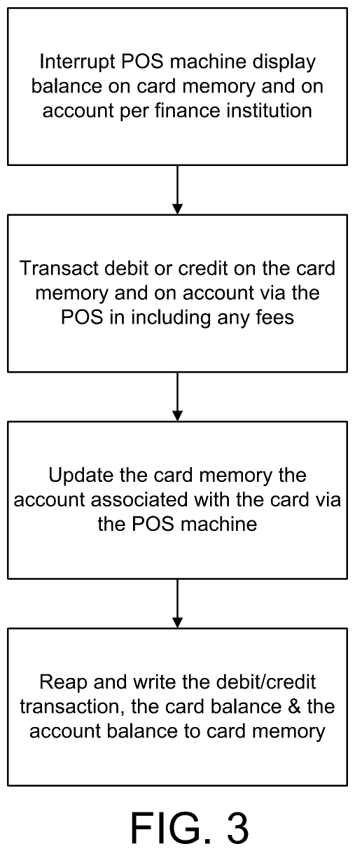

FIG. 3 is a flow chart of steps in a Point of Sale Account Card transaction in accordance with an embodiment of the present disclosure. The flow chart includes displaying a balance on the card and on an account associated with the card with a financial institution at a point of sale (POS) machine before a transaction with the card. The view also includes transacting a debit or credit on the card and the associated account via the POS machine with the financial institution to include any associated transaction fees. The flow chart yet includes updating the balance on the card and updating the account associated with the card via the POS machine with the financial institution per the debit or credit transaction. The view further includes reading and writing the debit or credit transaction to the card memory including the card balance and the account balance via the update circuit with the electronic logic. The card is used without and without a POS handshaking with the financial institution since a batch update is performed on the card at the next electronic business transaction.

The Point of Sale Account Card streamlines the consumer payment process by integrating real-time account balance information directly into card readers used at points of sale. Presently, consumers need to check their bank account balances through separate methods, such as mobile banking apps, ATMs, or online banking, before making a purchase. This necessity can prolong the buying process and yield feelings of frustration based on one's confidence regarding their financial means and related concerns about transactions being denied, which can be an embarrassing experience.

The Point of Sale Account Card introduces a combination bank access and transaction processing card that permits users to view their account balance immediately after engaging their card but before finalizing a transaction and then post-transaction having access to the final balance on the specified card utilized for purchasing. By providing this information at the moment of payment, and thereafter, the Point of Sale Account Card helps users make informed financial decisions to avoid potential overdrafts or declined transactions due to insufficient funds.

Promoting financial transparency, the Point of Sale Account Card functions similar to traditional readers employing touchless, swipe, or insert chip card recognition yet it serves to enhance convenience and efficiency in the purchasing process as a person no longer needs to interrupt their shopping to check their balance through other means, thus reducing the likelihood of unexpected payment issues while streamlining the overall transaction experience. Once the card is identified, the option to “see balance” is provided, if denied the device would process as usual, however, if accepted the device would inform the consumer of their balance and then offer the options for documentation post transaction via “Show On Screen Only”, “Show On Screen And Print” or “Print Only”.

Intended for use in diverse settings such as grocery stores, clothing stores, gas stations, branded convenience stores, etc. the Point of Sale Account Card also offers potential benefits for businesses by providing an opportunity to introduce a small service fee for accessing real-time consumer account information. This fee, while nominal, could contribute to the business's revenue stream and potentially be used to support charitable causes, aligning with corporate social responsibility goals.

Overall, the Point of Sale Account Card addresses practical problems related to financial transparency and purchasing convenience, benefiting both consumers and businesses alike. As a result, the Point of Sale Account Card is beneficial in the commercial/novelty industry.

Although the operations of the system and method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A card for electronic business transactions, the card comprising: an interrupt circuit configured on the card with electronic logic to display a balance on the card and on an account associated with the card with a financial institution at a point of sale (POS) machine before a transaction with the card;
a transaction circuit configured on the card with electronic logic to transact a debit or credit on the card and the associated account via the POS machine with the financial institution to include any associated transaction fees; and an update circuit configured on the card with electronic logic to update the balance on the card and update the account balance associated with the card via the POS machine with the financial institution per the debit or credit transaction; a card memory configured to read and to write the debit or credit transaction and the card balance and the account balance via the update circuit with the electronic logic.

2. The card of claim 1, further comprising electronic logic in the update circuit configured to update the account balance with the financial institution per the debit or credit transaction prior to a subsequent debit or credit transaction.

3. The card of claim 1, further comprising electronic logic in the update circuit configured to update the balance on the card per the debit or credit transaction prior to a subsequent debit or credit transaction.

4. The card of claim 1, wherein the interrupt circuit, the transaction circuit, the update circuit and the card memory reside on a single silicon chip.

5. The electronic transactions card of claim 1, wherein the card memory is a semiconductor electronic memory on the card powered by the POS machine.

6. The electronic transactions card of claim 1, wherein the card balance and the account balance are kept on a magnetic strip on the card read by the POS machine.

7. The electronic transactions card of claim 1, wherein the update circuit updates the debit or credit transaction amount.

8. The electronic transactions card of claim 1, wherein the card memory is a magnetic strip on a back of the card and read by the POS machine.

9. The electronic transactions card of claim 1, wherein the card memory comprises a personal profile of a user of the card including identifying information.

10. The electronic transactions card of claim 1, wherein the update circuits write to the card memory and the associated account including a place and a time of the interrupt and the debit or credit transaction.

11. The electronic transactions card of claim 1, wherein the card memory and the account associated with the card comprise passwords required to access the card and the account associated with the card.

12. The electronic transactions card of claim 1, wherein the transaction circuit further comprises an arithmetic circuit configured to compute the transaction and the fees associated with the transaction.

13. The electronic transactions card of claim 1, wherein the card comprises a magnetic strip configured to contain an information regarding the financial account.

14. The electronic transactions card of claim 1, wherein the financial account resides on an electronic cloud accessed via the POS machine.

15. The electronic transactions card of claim 1, wherein the financial account is recognized by a predetermined merchant and vendor including a bank.

16. The electronic transactions card of claim 1, wherein the transaction at the POS machine is a cash tender.
